(19) United States
(12) Patent Application Publication
(10) Pub. No.: US 2022/0138625 A1
(43) Pub. Date: May 5, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TAKASHI KOBAYASHI, TOKYO (JP)

(21) Appl. No.: 17/430,255

(22) PCT Filed: Feb. 14, 2020
(86) PCT No.: PCT/JP2020/005880

§ 371 Date: Aug. 11, 2021

(30) Foreign Application Priority Data
Feb. 21, 2019 (JP) 2019-029511

(51) Int. Cl. G06N 20/00; G06F 3/01; G06F 3/04847; G06F 3/0482; G06V 40/20; G06V 10/774; G06V 10/94

(52) U.S. Cl. CPC G06N 20/00; G06F 3/017; G06F 3/011; G06V 10/945; G06F 3/0482; G06V 40/28; G06V 10/774; G06F 3/04847

(57) ABSTRACT

Provided is an information processing apparatus that includes a control unit that controls a user interface that allows a user to determine whether to adopt collected first sensor data as learning data for machine learning. The control unit presents, on the user interface, the first sensor data, second sensor data that is collected together with the first sensor data, and a label candidate that is estimated from the second sensor data, and receives input related to determination on whether to adopt the first sensor data from the user.

### FIELD

The present disclosure relates to an information processing apparatus, an information processing method, and a program.

### BACKGROUND

In recent years, a technology for operating an apparatus by a gesture or the like has been developed. For example, Patent Literature 1 discloses a technology for recognizing a gesture of a user from a captured image, and controlling an apparatus based on the recognized gesture.

### CITATION LIST

### Patent Literature

Patent Literature 1: JP 2013-205983 A

### SUMMARY

### Technical Problem

In gesture recognition as described in Patent Literature 1, in many cases, a recognizer that is generated by a machine learning method is used. However, to generate a high-accuracy recognizer, it is needed to prepare a large amount of learning data and cost for labeling or the like tends to increase.

### Solution to Problem

According to the present disclosure, an information processing apparatus is provided that includes: a control unit that controls a user interface that allows a user to determine whether to adopt collected first sensor data as learning data for machine learning, wherein the control unit presents, on the user interface, the first sensor data, second sensor data that is collected together with the first sensor data, and a label candidate that is estimated from the second sensor data, and receives input related to determination on whether to adopt the first sensor data from the user.

Moreover, according to the present disclosure, an information processing method is provided that includes: controlling, by a processor, a user interface that allows a user to determine whether to adopt collected first sensor data as learning data for machine learning, wherein the controlling includes presenting, on the user interface, the first sensor data, second sensor data that is collected together with the first sensor data, and a label candidate that is estimated from the second sensor data, and receiving input related to determination on whether to adopt the first sensor data from the user.

Moreover, according to the present disclosure, a program is provided that causes a computer to function as an information processing apparatus that includes: a control unit that controls a user interface that allows a user to determine whether to adopt collected first sensor data as learning data for machine learning, wherein the control unit presents, on the user interface, the first sensor data, second sensor data that is collected together with the first sensor data, and a label candidate that is estimated from the second sensor data, and receives input related to determination on whether to adopt the first sensor data from the user.

### BRIEF DESCRIPTION OF DRAWINGS

FIG. 1 is a block diagram illustrating a functional configuration example of an information processing system according to one embodiment of the present disclosure.

FIG. 2 is a diagram for explaining a method of collecting first sensor data and second sensor data according to the present embodiment.

FIG. 3 is a flowchart illustrating the flow of generation of learning data by the information processing system according to the present embodiment.

FIG. 4 is a flowchart illustrating the flow of estimation of a label candidate according to the present embodiment.

FIG. 5 is a diagram illustrating an example of learning candidate data according to the present embodiment.

FIG. 6 is a flowchart illustrating the flow of presentation of data and generation of learning data according to the present embodiment.

FIG. 7 is a diagram illustrating an example of a user interface controlled by a control unit according to the present embodiment.

FIG. 8 is a diagram illustrating an example of the user interface controlled by the control unit according to the present embodiment.

FIG. 9 is a diagram illustrating an example of the user interface controlled by the control unit according to the present embodiment.

FIG. 10 is a diagram illustrating an example of a case in which the second sensor data according to the present embodiment is sound data.

FIG. 11 is a diagram for explaining an example in which a learning target according to the present embodiment is various states of an animal.

FIG. 12 is a block diagram illustrating a hardware configuration example of an information processing apparatus according to the present embodiment.

### DESCRIPTION OF EMBODIMENTS

Preferred embodiments of the present disclosure will be described in detail below with reference to the accompanying drawings. In the present specification and drawings, structural elements that have substantially the same functions and configurations will be denoted by the same reference symbols, and repeated explanation of the structural elements will be omitted.

In addition, hereinafter, explanation will be given in the following order.

1. Embodiment
1.1. Background
1.2. Functional configuration example
1.3. Flows of operation
1.4. Examples of user interface
1.5. Other application examples

2. Hardware configuration example

3. Conclusion

### 1. EMBODIMENT

1.1. Background

First, the background of the present disclosure will be described. As described above, in recent years, various apparatuses that recognize gestures and behaviors of users and perform operation based on recognition results have been developed. To recognize the gestures and the behaviors of the users, in many cases, a recognizer that is generated by using a machine learning method is used. The recognizer as described above is able to recognize the gestures and the behaviors of the users on the basis of sensor data that is collected by using an inertial sensor, a camera, or the like and learned knowledge.

When the recognizer is generated by using the machine learning method as described above, it is necessary to prepare a large amount of learning data. The learning data includes, for example, the sensor data as described above and a label corresponding to the sensor data. Here, the label as described above may be teaching information that indicates information to be written as a correct recognition result of machine learning using the sensor data. Accuracy of the label and the amount of learning data have a large impact on accuracy of the recognizer to be generated.

However, it is difficult to manually prepare the large amount of learning data in a complete manner. In particular, if labeling on the collected sensor data is manually performed, a large amount of human resource cost is needed.

For example, if labeling on image data that is acquired by a camera is to be performed, an operator needs to visually check a large amount of image data one by one and input a label.

Further, for example, if labeling on sensor data that is collected by a plurality of accelerometers is to be performed, it is necessary to extract an interval from start to end of a gesture and perform labeling for distinguishing a type of the gesture, with respect to chronological numerical data.

However, it is extremely difficult for an operator to intuitively perform the operation as described above without previous knowledge, and therefore, to realize the labeling, it is necessary to adopt a process of visualizing the sensor data or employ an operator with specialized knowledge, for example.

Further, even if it is presumed that certain sensor data is collected when a specified gesture is performed, it is important to scrutinize whether the sensor data is to be adopted as learning data. This is because the sensor data related to the gesture is likely to be affected by fluctuation due to a subject who performs the gesture, the number of times of performance, or the like. Therefore, it is important to select sensor data in accordance with target usage or recognition accuracy.

Furthermore, if labeling on a combination of a plurality of pieces of sensor data that are acquired from a plurality of sensors is to be performed, human resource cost for operation becomes enormous.

The technical idea according to the present disclosure has been conceived in view of the point as described above, and makes it possible to effectively reduce cost for labeling that is performed when learning data is to be secured. To cope with this, an information processing apparatus 30 that implements an information processing method according to one embodiment of the present disclosure includes a control unit 330 that determines whether to adopt collected first sensor data as learning data for machine learning. Further, as one of features of the control unit 330 according to one embodiment of the present disclosure, the control unit 330 presents, on a user interface, the first sensor data, second sensor data that is collected together with the first sensor data, and a label candidate that is estimated from the second sensor data, and receives input related to determination on whether to adopt the first sensor data from a user.

A functional configuration of the information processing apparatus 30 that has a feature as described above will be described in detail below.

1.2. Functional Configuration Example

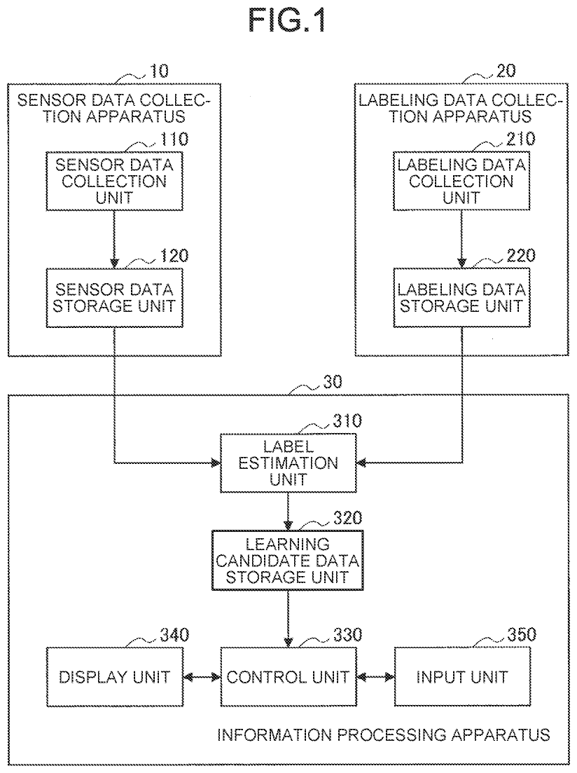

FIG. 1 is a block diagram illustrating a functional configuration example of an information processing system according to the present embodiment. As illustrated in FIG. 1, the information processing system according to the present embodiment includes a sensor data collection apparatus 10, a labeling data collection apparatus 20, and the information processing apparatus 30. Further, all of the apparatuses as described above are communicably connected to one another via a network.

Sensor Data Collection Apparatus 10

The sensor data collection apparatus 10 according to the present embodiment is an apparatus that collects the first sensor data according to the present embodiment. The first sensor data according to the present embodiment is sensor data as a target for which labeling is to be performed, and may be, for example, chronological data that is collected by various motion sensors.

Sensor Data Collection Unit 110

A sensor data collection unit 110 according to the present embodiment collects the first sensor data by using various motion sensors. Here, the motion sensors as described above are collective terms of sensors that detect acceleration, tilt, a direction, and the like of a sensing target. Therefore, the sensor data collection unit 110 according to the present embodiment is implemented by, for example, an accelerometer, a gyrometer, a geomagnetic sensor, or a combination of the above-described sensors.

Sensor Data Storage Unit 120

A sensor data storage unit 120 according to the present embodiment stores therein the first sensor data collected by the sensor data collection unit 110. In addition, the sensor data storage unit 120 inputs the first sensor data to the information processing apparatus 30 via the network.

Labeling Data Collection Apparatus 20

The labeling data collection apparatus 20 according to the present embodiment is an apparatus that collects labeling data (hereinafter, also referred to as the second sensor data) according to the present embodiment. The second sensor data according to the present embodiment is sensor data that improves efficiency of labeling operation with respect to the first sensor data. The second sensor data according to the present embodiment may be chronological data that is collected together with the first sensor data from the same sensing target. Further, the first sensor data and the second sensor data according to the present embodiment are different kinds of sensor data that are collected by different sensors.

Labeling Data Collection Unit 210

A labeling data collection unit 210 according to the present embodiment collects the second sensor data. The second sensor data according to the present embodiment is used for estimation of a label candidate by the information processing apparatus 30 or determination on appropriateness of the label candidate by a user, as will be described later. Therefore, the second sensor data according to the present embodiment may be sensor data with which the user is able to determine appropriateness of the label candidate as described above by viewing the second sensor data. The second sensor data according to the present embodiment includes, for example, image data and sound data. Therefore, the labeling data collection unit 210 according to the present embodiment includes a camera and a microphone.

Labeling Data Storage Unit 220

A labeling data storage unit 220 according to the present embodiment stores therein the second sensor data collected by the labeling data collection unit 210. In addition, the labeling data storage unit 220 inputs the second sensor data to the information processing apparatus 30 via the network.

Information Processing Apparatus 30

The information processing apparatus 30 according to the present embodiment controls a user interface that allows the user to determine whether to adopt the collected first sensor data as the learning data for the machine learning. The information processing apparatus 30 according to the present embodiment includes a label estimation unit 310, a learning candidate data storage unit 320, the control unit 330, a display unit 340, and an input unit 350.

Label Estimation Unit 310

The label estimation unit 310 according to the present embodiment estimates a label candidate corresponding to the first sensor data on the basis of the second sensor data. For example, if the second sensor data is image data, the label estimation unit 310 may include a trained recognizer that recognizes a gesture of a user form the image data.

Learning Candidate Data Storage Unit 320

The learning candidate data storage unit 320 according to the present embodiment stores therein, as learning candidate data, the first sensor data and the label candidate estimated by the label estimation unit 310 in an associated manner.

Control Unit 330

The control unit 330 according to the present embodiment controls the user interface that allows the user to determine whether to adopt the collected first sensor data as the learning data for the machine learning. As one of features of the control unit 330 according to the present embodiment, the control unit 330 presents, on the user interface, the learning candidate data as described above, i.e., the first sensor data and the label candidate, and the corresponding second sensor data, and receives input related to determination on whether to adopt the first sensor data from the user. Details of functions of the control unit 330 according to the present embodiment will be separately described later.

Display Unit 340

The display unit 340 according to the present embodiment displays the user interface as described above under the control of the control unit 330. Therefore, the display unit 340 according to the present embodiment includes various display devices.

Input Unit 350

The input unit 350 according to the present embodiment detects input operation performed by the user on the user interface as described above. Therefore, the input unit 350 according to the present embodiment includes an input device, such as a keyboard or a mouse.

Thus, the functional configuration of the information processing system according to the present embodiment has been described above. Meanwhile, the configuration described above with reference to FIG. 1 is one example, and the configurations of the information processing system and the information processing apparatus 30 according to the present embodiment are not limited to this example. For example, the functions of the information processing apparatus 30 according to the present embodiment may be implemented by being distributed to a plurality of devices. The configuration of the information processing system according to the present embodiment may be flexibly modified depending on specifications or operation.

1.3. Flows of Operation

Flows of operation performed by the information processing system according to the present embodiment will be described below. First, a method of collecting the first sensor data and the second sensor data according to the present embodiment will be described.

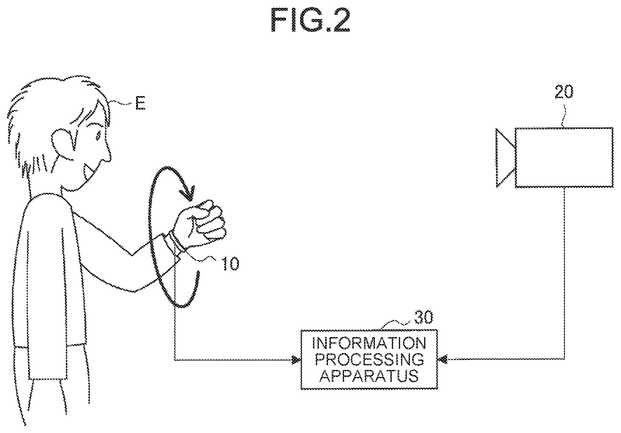

FIG. 2 is a diagram for explaining the method of collecting the first sensor data and the second sensor data according to the present embodiment. In an example illustrated in FIG. 2, an exemplary case is illustrated in which the first sensor data according to the present embodiment is used to train a recognizer that recognizes a gesture using a hand of the user from motion data, such as acceleration data or gyro data.

In this case, a subject E wears the wearable sensor data collection apparatus 10 on his/her wrist or the like or holds the sensor data collection apparatus 10 in his/her hand, and performs a gesture, for example. In this case, the sensor data collection apparatus 10 collects the first sensor data by an accelerometer, a gyrometer, or an inertial sensor that is a combination of the accelerometer and the gyrometer, and transmits the first sensor data to the information processing apparatus 30.

Further, at the same time, the labeling data collection apparatus 20 according to the present embodiment collects the second sensor data by adopting the subject E who performs the gesture as a sensing target. In the example illustrated in FIG. 2, the labeling data collection apparatus 20 collects image data (video data) related to the gesture of the subject E by the camera, and transmits the image data (video data) to the information processing apparatus 30. Meanwhile, the first sensor data and the second sensor data are stored together with a synchronized timestamp.

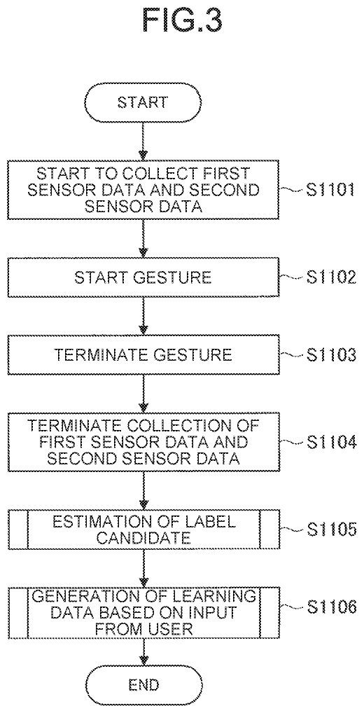

Next, a flow of generation of learning data by the information processing system according to the present embodiment will be described. FIG. 3 is a flowchart illustrating the flow of generation of learning data by the information processing system according to the present embodiment.

With reference to FIG. 3, first, the sensor data collection apparatus 10 starts to collect the first sensor data and the second sensor data (S1101).

Subsequently, the subject E starts a gesture (S1102), and terminates the gesture (S1103). In this case, the subject E may perform a plurality of different gestures in sequence, or may perform motion different from a recognition target gesture.

Further, if the subject E terminates the gesture, the sensor data collection apparatus 10 and the labeling data collection apparatus 20 respectively terminate collection of the first sensor data and the second sensor data (S1104).

Subsequently, the information processing apparatus 30 estimates a label candidate on the basis of the collected first sensor data and the collected second sensor data (S1105).

Subsequently, the information processing apparatus 30 presents, on the user interface, the first sensor data, the second sensor data, and the label candidate, and generates learning data to be used for machine learning on the basis of input from the user (S1106).

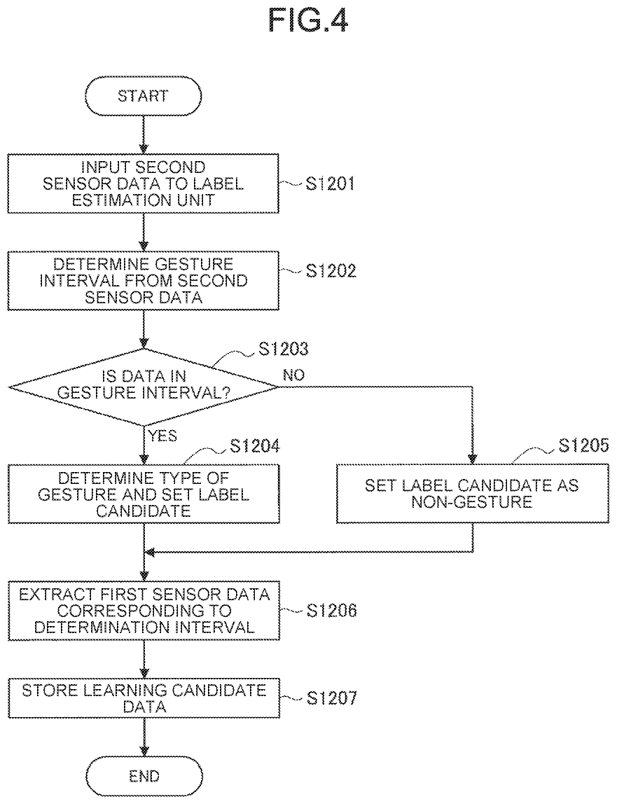

Next, a flow of estimation of a label candidate at Step S1104 as described above will be described. FIG. 4 is a flowchart illustrating the flow of estimation of a label candidate according to the present embodiment.

With reference to FIG. 4, first, the second sensor data is input to the label estimation unit 310 (S1201).

Subsequently, the label estimation unit 310 estimates a gesture interval from the second sensor data (S1202).

Then, with respect to data in the gesture interval determined at S1202 (Step S1203: YES), the label estimation unit 310 determines a type of the gesture and sets a label candidate (S1204).

In contrast, with respect to data in other than the gesture interval determined at Step S1202 (S1203: NO), the label estimation unit 310 sets a label candidate as a non-gesture (S1205). Meanwhile, the label estimation unit 310 may detect the gesture interval and determine a type of the gesture by using a well-known method.

Subsequently, the label estimation unit 310 extracts the first sensor data corresponding to a determination interval (S1206), and stores, as the learning candidate data, the first sensor data in association with the selected label candidate in the learning candidate data storage unit 320 (S1207).

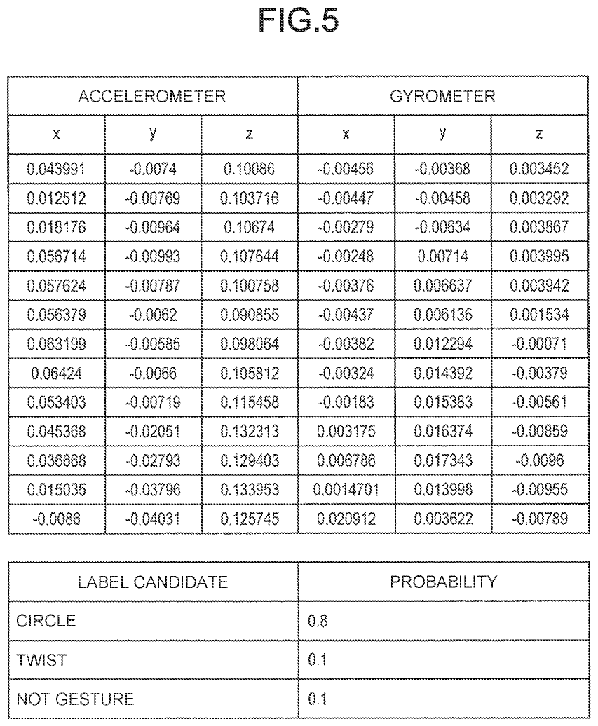

FIG. 5 is a diagram illustrating an example of the learning candidate data according to the present embodiment. FIG. 5 illustrates an example in which the first sensor data according to the present embodiment is acceleration data and gyro data, and a recognition target is a gesture using a hand. In this case, the learning candidate data is formed of a combination of chronological variable values of the acceleration data and the gyro data, and a label candidate.

As illustrated in the figure, a plurality of label candidates according to the present embodiment may be provided, and the learning candidate data may include a likelihood (probability) with respect to each of the label candidates.

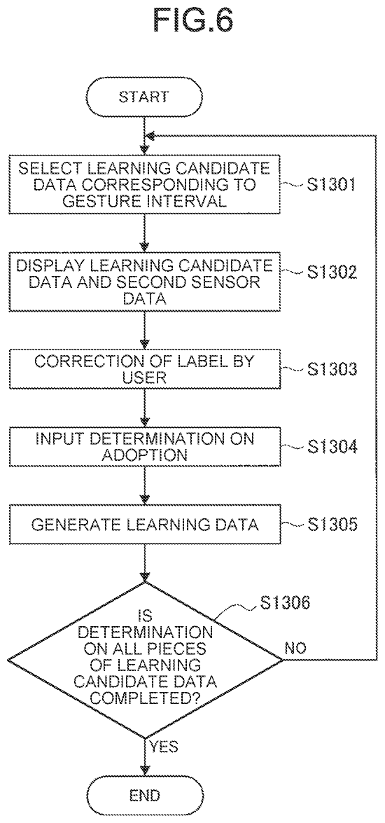

Next, a flow of presentation of data and generation of the learning data according to the present embodiment will be described. FIG. 6 is a flowchart illustrating the flow of presentation of data and generation of the learning data according to the present embodiment.

With reference to FIG. 6, first, the control unit 330 selects learning candidate data corresponding to the gesture interval (S1301).

Subsequently, the control unit 330 displays, on the user interface, the learning candidate data selected at Step S1301 and the second sensor data corresponding to the learning candidate data (S1302). In this manner, the control unit 330 need not present data that is estimated as the gesture interval to the user. With this control, it is possible to reduce the number of pieces of data that the user needs to process and reduce operational cost.

Then, the user refers to the learning candidate data and the second sensor data that are displayed at Step S1302, and performs input related to label correction or the like (S1303).

Further, the user performs input related to determination on whether to adopt the first sensor data as the learning data (S1304).

Subsequently, the control unit 330 generates learning data to be used for machine learning by, for example, updating the learning candidate data on the basis of information that is input at Step S1303 (S1305).

Then, the control unit 330 determines whether determination on adoption on all pieces of the learning candidate data is completed (S1306).

Here, if the learning candidate data for which the determination on adoption is not performed is present (S1306: NO), the control unit 330 returns to Step S1301 and repeats the subsequent operation.

In contrast, if the determination on adoption on all pieces of the learning candidate data is completed (S1306: YES), the control unit 330 terminates the process.

1.4. Examples of User Interface

Examples of the user interface controlled by the control unit 330 according to the present embodiment will be described below. As described above, the user interface according to the present embodiment may allow the user to determine whether to adopt the first sensor data. Further, the user may be allowed to select or modify the label candidate estimated by the label estimation unit 310 via the user interface.

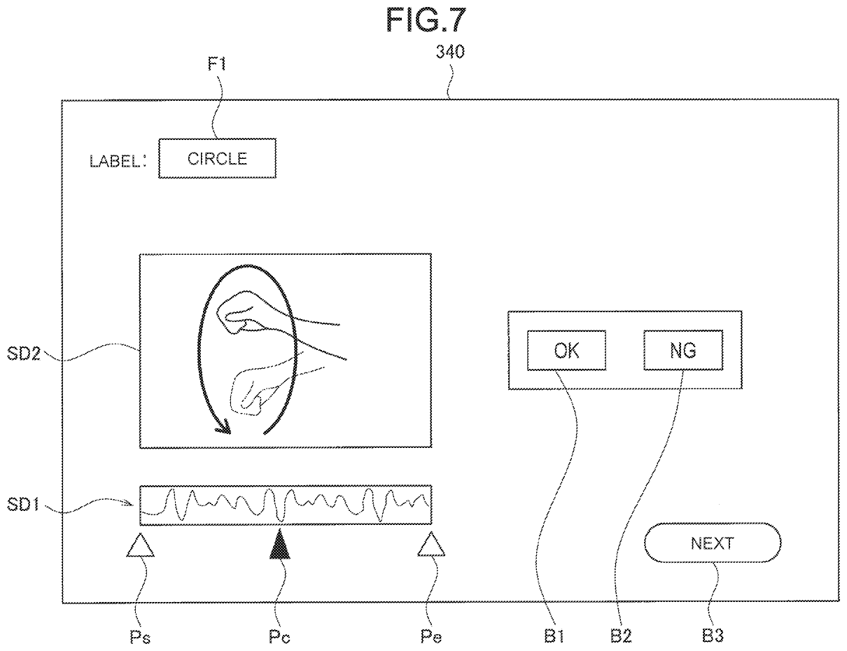

FIG. 7 to FIG. 9 are diagrams illustrating examples of the user interface controlled by the control unit 330 according to the present embodiment. Meanwhile, FIG. 7 to FIG. 9 illustrate examples of a case in which the first sensor data is acceleration data, gyro data, or the like related to a gesture using a hand of the user, and the second sensor data is image data obtained by capturing an image of the gesture.

With reference to FIG. 7, a graph related to first sensor data SD1, second sensor data SD2, a label candidate, and the like are displayed on the user interface according to the present embodiment. For example, the user is able to determine appropriateness of the estimated label candidate by viewing the second sensor data SD2 and comparing the second sensor data SD2 with the label candidate displayed in a field F1. To cope with this, the control unit 330 according to the present embodiment may display a pointer Pc that indicates a position of the first sensor data SD1 chronologically corresponding to a replay position of the second sensor data SD2.

Here, if the user determines that the label candidate is appropriate, the user is able to determine adoption of the first sensor data SD for which the label candidate is used as a label, by pressing a button B1 or the like.

In contrast, if the displayed label candidate is not appropriate, the user may perform correction by inputting text corresponding to a correct label in the field F1 and thereafter press the button B1. In this case, the first sensor data SD for which the input text is used as the label may be used as the learning data. In this manner, the control unit 330 according to the present embodiment may receive, on the user interface, input of a label corresponding to the first sensor data from the user.

In contrast, if the user views the second sensor data SD and determines that a corresponding interval is not an interval in which the image of the gesture is captured, the user is able to determine that the first sensor data SD is not to be used for the machine learning, by pressing a button B2 or the like.

In this manner, according to the user interface of the present embodiment, by viewing the second sensor data that is chronologically synchronized with the first sensor data, the user is able to intuitively determine whether extraction of a gesture interval and estimation of a label candidate are correctly performed, so that it is possible to realize determination on adoption for learning at reduced cost.

Furthermore, the control unit 330 according to the present embodiment may receive, on the user interface, a change of a start position or an end position of the first sensor data to be adopted as the learning data from the user. For example, if the user views the second sensor data SD2 and determines that an interval that is not a gesture interval is included at the top or at the end of the interval, the user may be allowed to adjust a pointer Ps that indicates the start position of the first sensor data and a pointer Pe that indicates the end position of the first sensor data to change the start position and the end position of the first sensor data to be adopted. With this configuration, even if extraction accuracy of the gesture interval is inappropriate, the user is able to easily perform correction.

If correction of the label or the gesture interval and determination on adoption are completed, the user is able to move to determination operation on next learning candidate data by pressing a button B3 or the like.

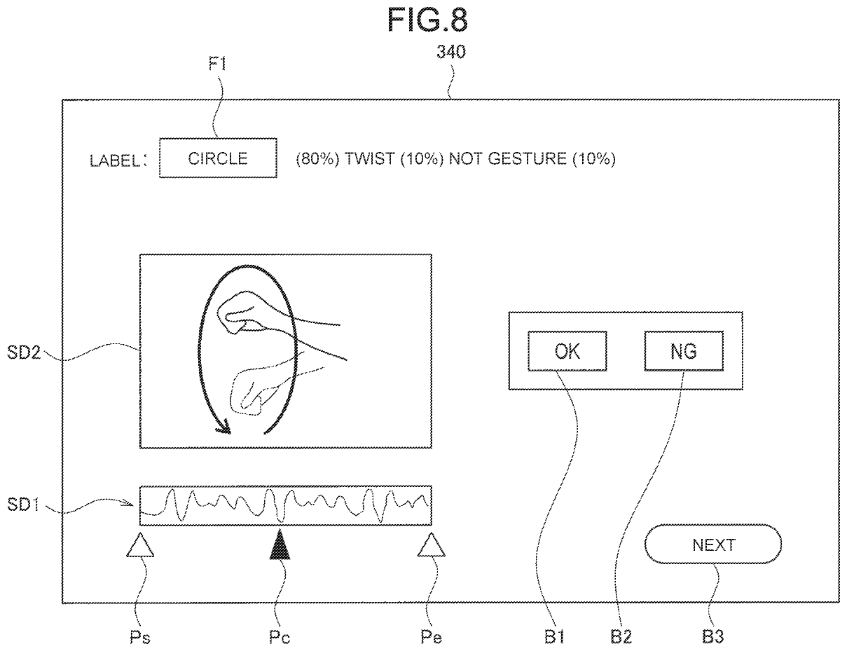

While FIG. 7 illustrates a case in which a single label candidate is displayed on the user interface, the control unit 330 according to the present embodiment may present a plurality of label candidates estimated by the label estimation unit 310 and adopt a label candidate selected by the user as a label to be used for the machine learning as illustrated in FIG. 8. Further, in this case, as illustrated in the figure, the control unit 330 according to the present embodiment may present a likelihood of each of the label candidates.

Furthermore, the control unit 330 may allow the user to select a plurality of label candidates from among the presented label candidates. In this case, the control unit 330 may associate a plurality of labels with the first sensor data and adopt them as the learning data. For example, in multiple-class classification, it is assumed that a certain case may be classified into a plurality of classes.

Moreover, the control unit 330 according to the present embodiment may generate new first sensor data by receiving editing operation on the second sensor data from the user and changing original first sensor data on the basis of the editing operation.

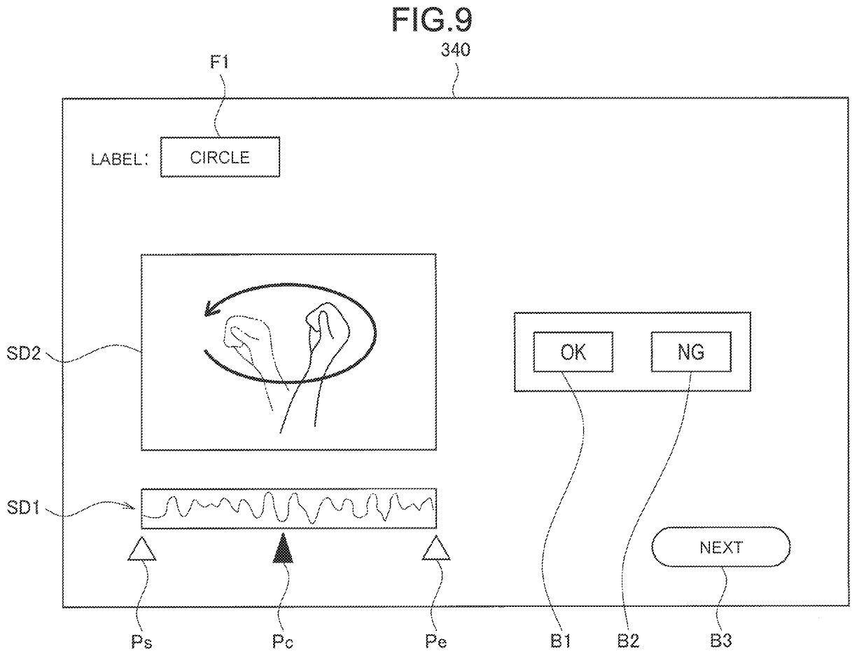

For example, in the example illustrated in FIG. 9, the user rotates the second sensor data SD2 by 90 degrees in the clockwise direction from the state illustrated in FIG. 7. In this manner, the editing operation as described above may include rotation operation on the second sensor data. Furthermore, in this case, the control unit 330 according to the present embodiment is able to generate new first sensor data SD for which a coordinate axis with respect to the original first sensor data SD1 is rotated on the basis of the rotation operation as described above.

According to the above-described functions of the control unit 330 of the present embodiment, it is possible to easily change the first sensor data, perform correction to obtain learning data with improved accuracy, and generate new learning data through intuitive operation. Meanwhile, the editing operation according to the present embodiment includes a change of a replay speed, reverse replay, and the like in addition to the rotation operation as described above.

1.5. Other Application Examples

The example of the user interface according to the present embodiment has been described above. Meanwhile, the case in which the learning target according to the present embodiment is a gesture using a hand, the first sensor data is motion data, and the second sensor data is image data has been described above as a main example. However, an application example of the learning target, the first sensor data, and the second sensor data according to the present embodiment is not limited to the example as described above.

For example, the learning target according to the present embodiment may be a gesture that is synchronized with sound that occurs with music instrument performance, rhythm dance, or the like. In this case, the second sensor data according to the present embodiment may be sound data.

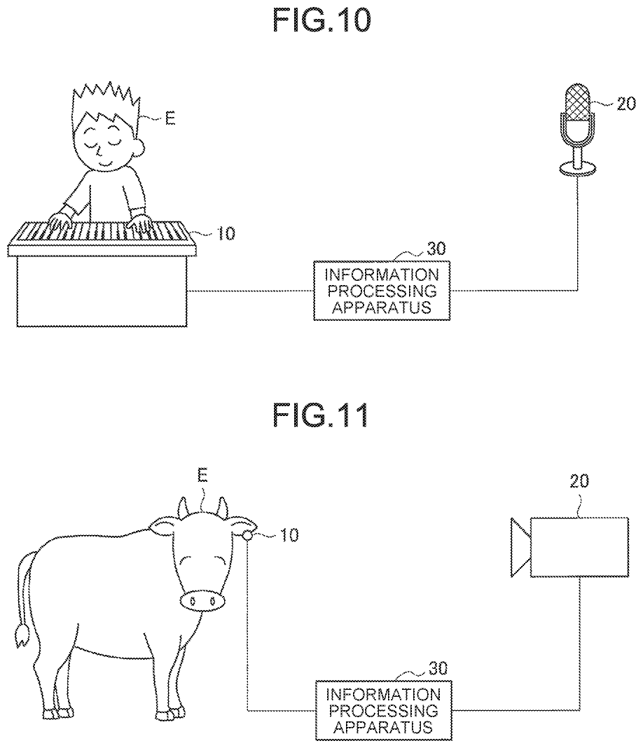

FIG. 10 is a diagram illustrating an example of a case in which the second sensor data according to the present embodiment is sound data. In this case, the sensor data collection apparatus 10 according to the present embodiment is implemented as an instrument-type apparatus as illustrated in the figure for example, and inputs the first sensor data that is acquired through performance given by a user to the information processing apparatus 30. Further, in this case, the labeling data collection apparatus 20 according to the present embodiment inputs, as the second sensor data, sound data that is collected by the microphone to the information processing apparatus 30.

The information processing apparatus 30 may estimate a candidate label through the flow as illustrated in FIG. 4, on the basis of the input first sensor data and the input second sensor data. However, in this case, the gesture interval is extracted by using a well-known technique corresponding to the sound data, instead of the image data.

Furthermore, if the second sensor data is sound data, the information processing apparatus 30 may perform control, on the user interface, such that the sound data can be replayed on the image data. With this control, the user who has listened the sound data is able to intuitively determine the gesture interval or determine whether the gesture itself is expected motion (for example, whether correct performance is given, or the like), and is able to correct a label or the like or determine whether to adopt the data as the learning data.

Moreover, for example, the learning target according to the present embodiment may be a state or the like related to other than a human. FIG. 11 is a diagram for explaining an example in which the learning target according to the present embodiment is various states of an animal. Examples of the various states as described above include a health condition, a degree of growth, and a degree of activity of an animal as a sensing target.

In this case, the sensor data collection apparatus 10 according to the present embodiment may be implemented as a small device that is worn by the animal. The sensor data collection apparatus 10 inputs, as the first sensor data, collected acceleration data, collected gyro data, collected brain wave data, collected positional data, or the like to the information processing apparatus. Furthermore, in this case, the labeling data collection apparatus 20 according to the present embodiment may input, as the second sensor data, image data that is collected by the camera to the information processing apparatus 30. The information processing apparatus 30 is able to estimate a candidate label and generate learning data through the flows as described above, on the basis of the input first sensor data and the input second sensor data.

Thus, the features of the information processing method according to the present embodiment have been described in detail above. According to the information processing method of the present embodiment, it is possible to easily generate the learning data that is needed for the machine learning, and largely and effectively reduce human cost related to an operator for labeling or the like.

Furthermore, as described above, an application range of the present technical idea is not limited to a case in which specific sensor data is handled, but the present technical idea may be applied to various kinds of sensor data and learning targets. Therefore, according to the present technical idea, it is expected to achieve broader effects when a machine learning method is used for an industrial purpose.

Meanwhile, it may be possible to use a plurality of pieces of the first sensor data and the second sensor data according to the present embodiment. With this configuration, for example, it may be possible to perform labeling on a plurality of pieces of first sensor data on the basis of a single piece of second sensor data or perform interval extraction and estimation of a label candidate with higher accuracy on the basis of a plurality of pieces of second sensor data.

Furthermore, details of correction of a label and an interval by the user may be fed back to the label estimation unit 310. The label estimation unit 310 is able to improve accuracy of the interval extraction and the estimation of a label candidate by performing learning again by using the second sensor data corresponding to the details of the correction as described above.

### 2. HARDWARE CONFIGURATION EXAMPLE

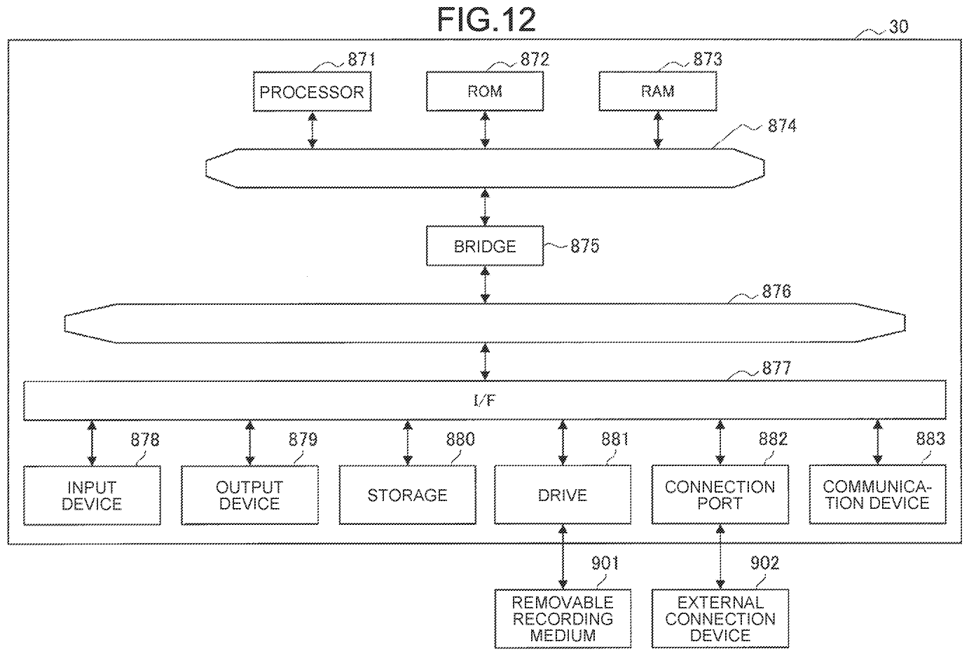

Next, a hardware configuration example of the information processing apparatus 30 according to one embodiment of the present disclosure will be described. FIG. 12 is a block diagram illustrating an example of a hardware configuration of the information processing apparatus 30 according to one embodiment of the present disclosure. As illustrated in FIG. 12, the information processing apparatus 30 includes, for example, a processor 871, a read only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. Meanwhile, the hardware configuration described herein is one example, and a part of the structural elements may be omitted. Further, structural elements other than the structural elements described herein may further be included.

Processor 871

The processor 871 functions as, for example, an arithmetic processing device or a control device, and controls the whole or a part of operation of each of the structural elements on the basis of various programs that are stored in the ROM 872, the RAM 873, the storage 880, or a removable recording medium 901.

ROM 872 and RAM 873

The ROM 872 is a means for storing a program to be read by the processor 871, data used for calculation, and the like. The RAM 873 temporarily or permanently stores therein, for example, a program to be read by the processor 871, various parameters that are appropriately changed when the program is executed, and the like.

Host Bus 874, Bridge 875, External Bus 876, and Interface 877

The processor 871, the ROM 872, and the RAM 873 are connected to one another via the host bus 874 capable of performing high-speed data transmission, for example. In contrast, the host bus 874 is connected to the external bus 876, for which a data transmission speed is relatively low, via the bridge 875, for example. Further, the external bus 876 is connected to various structural elements via the interface 877.

Input Device 878

As the input device 878, for example, a mouse, a keyboard, a touch panel, a button, a switch, a lever, and the like are used. Further, as the input device 878, a remote controller (hereinafter, referred to as a remote) capable of transmitting a control signal by using infrared or other radio waves may be used. Furthermore, the input device 878 includes a voice input device, such as a microphone.

Output Device 879

The output device 879 is, for example, a display device, such as a cathode ray tube (CRT), a liquid crystal display (LCD), or an organic electroluminescence (EL), an audio output device, such as a speaker or headphones, or a certain device, such as a printer, a mobile phone, or a facsimile machine, that is able to visually or auditorily transfer acquired information to a user. Further, the output device 879 according to the present disclosure includes various vibration devices that are able to output tactile stimulation.

Storage 880

The storage 880 is a device for storing various kinds of data. Examples of the storage 880 include a magnetic storage device, such as a hard disk drive (HDD), a semiconductor storage device, an optical storage device, or a magneto optical storage device.

Drive 881

The drive 881 is, for example, a device that reads information stored in the removable recording medium 901, such as a magnetic disk, an optical disk, a magneto optical disk, or a semiconductor memory, or writes information to the removable recording medium 901.

Removable Recording Medium 901

The removable recording medium 901 is, for example, various semiconductor storage media, such as a digital versatile disk (DVD) medium, a Blu-ray (registered trademark) medium, or an HD DVD medium. The removable recording medium 901 may also be an integrated circuit (IC) card equipped with a contactless IC chip, an electronic device, or the like, for example.

Connection Port 882

The connection port 882 is, for example, a port, such as a universal serial bus (USB) port, an IEEE 1394 port, a small computer system interface (SCSI), an RS-232C port, or an optical audio terminal, for connecting an external connection device 902.

External Connection Device 902

The external connection device 902 is, for example, a printer, a mobile music player, a digital camera, a digital video camera, an IC recorder, or the like.

Communication Device 883

The communication device 883 is a communication device for establishing a connection to a network, and is, for example, a communication card for a wired or wireless LAN, Bluetooth (registered trademark), or a wireless USB (WUSB), a router for optical communication, a router for asymmetric digital subscriber line (ADSL), a modem for various kinds of communication, or the like.

### 3. CONCLUSION

As described above, the information processing apparatus 30 that implements the information processing method according to one embodiment of the present disclosure includes the control unit 330 that controls the user interface that allows the user to determine whether to adopt the collected first sensor data as the learning data for the machine learning. Furthermore, the control unit 330 according to one embodiment of the present disclosure presents, on the user interface, the first sensor data, the second sensor data that is collected together with the first sensor data, and the label candidate that is estimated from the second sensor data, and receives input related to determination on whether to adopt the first sensor data from the user. With this configuration, it is possible to effectively reduce cost for labeling that is performed when learning data is to be secured.

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the technical idea described in the appended claims, and it should be understood that they will naturally come under the technical scope of the present disclosure.

Further, the effects described above are merely illustrative or exemplified effects, and are not limitative. That is, with or in the place of the above effects, the technology according to the present disclosure may achieve other effects that are clear to those skilled in the art from the description of this specification.

Furthermore, it is possible to generate a computer program that causes hardware, such as a CPU, a ROM, and a ROM, incorporated in a computer to implement the same functions as those of the information processing apparatus 30, and it is possible to provide a non-transitory computer-readable recording medium that stores therein the program.

Moreover, each of Steps in processes performed by the information processing system in the present specification need not always be chronologically performed in the same order as illustrated in the flowcharts. For example, each of Steps in the processes performed by the information processing system may be performed in different order from the order illustrated in the flowcharts, or may be performed in a parallel manner.

In addition, the following configurations are also within the technical scope of the present disclosure.

(1)

An information processing apparatus comprising:

a control unit that controls a user interface that allows a user to determine whether to adopt collected first sensor data as learning data for machine learning, wherein

the control unit presents, on the user interface, the first sensor data, second sensor data that is collected together with the first sensor data, and a label candidate that is estimated from the second sensor data, and receives input related to determination on whether to adopt the first sensor data from the user.

(2)

The information processing apparatus according to (1), wherein the first sensor data and the second sensor data are chronological data that are collected from a same sensing target.

(3)

The information processing apparatus according to (2), wherein the control unit presents, on the user interface, the first sensor data and the second sensor data in a chronologically associated manner.

(4)

The information processing apparatus according to (3), wherein the second sensor data is sensor data with which the user is able to determine appropriateness of the estimated label candidate by viewing the second sensor data.

(5)

The information processing apparatus according to (4), wherein the second sensor data is one of image data and sound data.

(6)

The information processing apparatus according to (4) or (5), wherein the first sensor data and the second sensor data are different kinds of sensor data that are collected from different sensors.

(7)

The information processing apparatus according to any one of (3) to (6), wherein the control unit presents a position of the first sensor data chronologically corresponding to a replay position of the second sensor data.

(8)

The information processing apparatus according to any one of (1) to (7), wherein the control unit receives, on the user interface, input of a label corresponding to the first sensor data from the user.

(9)

The information processing apparatus according to any one of (1) to (8), wherein the control unit presents, on the user interface, a plurality of pieces of estimated label candidates, and adopts a label candidate selected by the user as a label used for the machine learning.

(10)

The information processing apparatus according to (9), wherein the control unit presents, on the user interface, a likelihood of each of the label candidates.

(11)

The information processing apparatus according to any one of (1) to (10), wherein the control unit receives, on the user interface, a change of at least one of a start position and an end position of the first sensor data that is adopted as the learning data from the user.

(12)

The information processing apparatus according to any one of (1) to (11), wherein the control unit receives, on the user interface, editing operation on the second sensor data from the user, and generates new first sensor data on the basis of the editing operation.

(13)

The information processing apparatus according to (12), wherein the control unit receives rotation operation on the second sensor data from the user, and generates new first sensor data for which a coordinate axis with respect to the first sensor data is rotated on the basis of the rotation operation.

(14)

The information processing apparatus according to any one of (1) to (13), wherein the first sensor data includes at least sensor data collected by a motion sensor.

(15)

The information processing apparatus according to any one of (1) to (14), further comprising:

a label estimation unit that estimates the label candidate on the basis of the second sensor data.

(16)

An information processing method comprising:

controlling, by a processor, a user interface that allows a user to determine whether to adopt collected first sensor data as learning data for machine learning, wherein

the controlling includes
presenting, on the user interface, the first sensor data, second sensor data that is collected together with the first sensor data, and a label candidate that is estimated from the second sensor data, and
receiving input related to determination on whether to adopt the first sensor data from the user.
   (17)

A program that causes a computer to function as an information processing apparatus that includes:

a control unit that controls a user interface that allows a user to determine whether to adopt collected first sensor data as learning data for machine learning, wherein

the control unit presents, on the user interface, the first sensor data, second sensor data that is collected together with the first sensor data, and a label candidate that is estimated from the second sensor data, and receives input related to determination on whether to adopt the first sensor data from the user.

### REFERENCE SIGNS LIST

10 sensor data collection apparatus
110 sensor data collection unit
120 sensor data storage unit
20 labeling data collection apparatus
210 labeling data collection unit
220 labeling data storage unit
30 information processing apparatus
310 label estimation unit
320 learning candidate data storage unit
330 control unit
340 display unit
350 input unit

1. An information processing apparatus comprising:
a control unit that controls a user interface that allows a user to determine whether to adopt collected first sensor data as learning data for machine learning, wherein
the control unit presents, on the user interface, the first sensor data, second sensor data that is collected together with the first sensor data, and a label candidate that is estimated from the second sensor data, and receives input related to determination on whether to adopt the first sensor data from the user.

2. The information processing apparatus according to claim 1, wherein the first sensor data and the second sensor data are chronological data that are collected from a same sensing target.

3. The information processing apparatus according to claim 2, wherein the control unit presents, on the user interface, the first sensor data and the second sensor data in a chronologically associated manner.

4. The information processing apparatus according to claim 3, wherein the second sensor data is sensor data with which the user is able to determine appropriateness of the estimated label candidate by viewing the second sensor data.

5. The information processing apparatus according to claim 4, wherein the second sensor data is one of image data and sound data.

6. The information processing apparatus according to claim 4, wherein the first sensor data and the second sensor data are different kinds of sensor data that are collected from different sensors.

7. The information processing apparatus according to claim 3, wherein the control unit presents a position of the first sensor data chronologically corresponding to a replay position of the second sensor data.

8. The information processing apparatus according to claim 1, wherein the control unit receives, on the user interface, input of a label corresponding to the first sensor data from the user.

9. The information processing apparatus according to claim 1, wherein the control unit presents, on the user interface, a plurality of pieces of estimated label candidates, and adopts a label candidate selected by the user as a label used for the machine learning.

10. The information processing apparatus according to claim 9, wherein the control unit presents, on the user interface, a likelihood of each of the label candidates.

11. The information processing apparatus according to claim 1, wherein the control unit receives, on the user interface, a change of at least one of a start position and an end position of the first sensor data that is adopted as the learning data from the user.

12. The information processing apparatus according to claim 1, wherein the control unit receives, on the user interface, editing operation on the second sensor data from the user, and generates new first sensor data on the basis of the editing operation.

13. The information processing apparatus according to claim 12, wherein the control unit receives rotation operation on the second sensor data from the user, and generates new first sensor data for which a coordinate axis with respect to the first sensor data is rotated on the basis of the rotation operation.

14. The information processing apparatus according to claim 1, wherein the first sensor data includes at least sensor data collected by a motion sensor.

15. The information processing apparatus according to claim 1, further comprising:
a label estimation unit that estimates the label candidate on the basis of the second sensor data.

16. An information processing method comprising:
controlling, by a processor, a user interface that allows a user to determine whether to adopt collected first sensor data as learning data for machine learning, wherein
the controlling includes
presenting, on the user interface, the first sensor data, second sensor data that is collected together with the first sensor data, and a label candidate that is estimated from the second sensor data, and
receiving input related to determination on whether to adopt the first sensor data from the user.

17. A program that causes a computer to function as an information processing apparatus that includes:
a control unit that controls a user interface that allows a user to determine whether to adopt collected first sensor data as learning data for machine learning, wherein
the control unit presents, on the user interface, the first sensor data, second sensor data that is collected together with the first sensor data, and a label candidate that is estimated from the second sensor data, and receives input related to determination on whether to adopt the first sensor data from the user.
